(19) United States
(12) Patent Application Publication
(10) Pub. No.: US 2025/0317722 A1
(43) Pub. Date: Oct. 9, 2025

(54) ENABLING EMERGENCY CALLS AND PUBLIC SAFETY SERVICES SUPPORT

(71) Applicant: Lenovo (Singapore) Pte. Limited, Singapore (SG)

(72) Inventors: Prateek Basu Mallick, Dreieich (DE); Joachim Löhr, Wiesbaden (DE)

(73) Assignee: Lenovo (Singapore) Pte. Limited, Singapore (SG)

(21) Appl. No.: 19/084,650

(22) Filed: Mar. 19, 2025

Related U.S. Application Data
(60) Provisional application No. 63/574,223, filed on Apr. 3, 2024.

(51) Int. Cl. H04W 4/90; H04W 48/08; H04W 48/20

(52) U.S. Cl. CPC H04W 4/90; H04W 48/08; H04W 48/20

(57) ABSTRACT

Various aspects of the present disclosure relate to enabling emergency calls and public safety services support. A user equipment (UE) may receive a master information block (MIB) including a cell barred information element (IE). The UE may receive a system information block type 1 (SIB1). The UE may determine whether the MIB indicates that the UE is barred for a cell. In response to the UE being barred for the cell, the UE may determine whether the SIB1 includes a cell barred exception IE that indicates an exception for emergency communication on the barred cell. In response to the SIB1 including the cell barred exception IE, The UE may assign the cell as an acceptable cell for the UE to camp for limited services, including the emergency communication.

### RELATED APPLICATION

This application claims priority to U.S. Provisional Application Ser. No. 63/574,223 filed Apr. 3, 2024 entitled “Apparatus and Method for Enabling Emergency Calls and Public Safety Services Support,” the disclosure of which is incorporated by reference herein in its entirety.

### TECHNICAL FIELD

The present disclosure relates to wireless communications, and more specifically to an apparatus and method for enabling emergency calls and public safety services support.

### BACKGROUND

A wireless communications system may include one or multiple network communication devices, which may be otherwise known as network equipment (NE), supporting wireless communications for one or multiple user communication devices, which may be otherwise known as user equipment (UE), user devices, or other suitable terminology. The wireless communications system may support wireless communications with the one or multiple user communication devices by utilizing resources, such as time resources (e.g., symbols, slots, subframes, frames, or the like) and/or frequency resources (e.g., subcarriers, carriers, or the like), of the wireless communication system. Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

In some implementations of the method and apparatuses, described herein, a Master Information Block (MIB), which has cell access status information including a potential indication of a status of barred from a first base station, is received. A System Information Block Type 1 (SIB1) is then received from the first base station. A determination is then made, as to whether the MIB indicates a UE cell access status of barred for a cell associated with the first base station. In response to determining that the cell access status information indicates a barred status for the cell associated with the first base station, a determination is made, as to whether the SIB1 includes an Information Element (IE) that indicates a barred cell status exception for emergency information messaging. In response to determining that the SIB1 includes an IE that indicates a barred cell status exception for emergency information messaging, an active cell selection for the cell associated with the first base station is established for at least a limited purpose of supporting emergency information messaging.

In some implementations of the method and apparatuses described herein, cell access status information is determined for at least a particular User Equipment (UE). A MIB including the cell access status information including a potential indication of a status of barred from a first base station is transmitted. In response to determining that the cell access status information for at least the particular UE indicates a barred status for the cell associated with the first base station, a determination is made, as to whether an IE that indicates a barred cell status exception for emergency information messaging should be made for at least a limited purpose of supporting emergency information messaging. In response to determining that the barred cell status exception for emergency information messaging should be made for the at least particular UE, a SIB1 from the first base station, which includes the barred cell status exception, is transmitted.

A UE for wireless communication is described. The UE may be configured to, capable of, or operable to perform one or more operations as described herein. For example, the UE may be configured to, capable of, or operable to receive a MIB including a cell barred IE; receive a SIB1; determine whether the MIB indicates that the UE is barred for a cell; in response to the UE being barred for the cell, determine whether the SIB1 includes a cell barred exception IE that indicates an exception for emergency communication on the barred cell; and in response to the SIB1 including the cell barred exception IE, assign the cell as an acceptable cell for the UE to camp for limited services, including the emergency communication.

A processor (e.g., a standalone processor chipset, or a component of a UE) for wireless communication is described. The processor may be configured to, capable of, or operable to perform one or more operations as described herein. For example, the processor may be configured to, capable of, or operable to receive a MIB including a cell barred IE; receive a SIB1; determine whether the MIB indicates that a UE is barred for a cell; in response to the UE being barred for the cell, determine whether the SIB1 includes a cell barred exception IE that indicates an exception for emergency communication on the barred cell; and in response to the SIB1 including the cell barred exception IE, assign the cell as an acceptable cell for the UE to camp for limited services, including the emergency communication.

A method performed or performable by a UE for wireless communication is described. The method may include receiving a MIB including a cell barred IE; receiving a SIB1; determining whether the MIB indicates that the UE is barred for a cell; in response to the UE being barred for the cell, determining whether the SIB1 includes a cell barred exception IE that indicates an exception for emergency communication on the barred cell; and in response to the SIB1 including the cell barred exception IE, assigning the cell as an acceptable cell for the UE to camp for limited services, including the emergency communication.

In some implementations of the UE, the processor, and the method described herein, the UE, the processor, and the method may be configured to, capable of, or operable to camp on the cell for the limited services, including the emergency communication. In some implementations of the UE, the processor, and the method described herein, the cell barred exception IE has a Boolean value. In some implementations of the UE, the processor, and the method described herein, the UE, the processor, and the method may be configured to, capable of, or operable to assign the cell as the acceptable cell for the UE to camp for the limited services based on the Boolean value of true. In some implementations of the UE, the processor, and the method described herein, the barred exception IE is only included in the SIB1.

A base station for wireless communication is described. The base station may be configured to, capable of, or operable to perform one or more operations as described herein. For example, the base station may be configured to, capable of, or operable to transmit, to a UE, a MIB including a cell barred IE for a cell associated with the base station; and transmit, to the UE, a SIB1, where the SIB1 includes a cell barred exception IE that indicates an exception for emergency communication on the barred cell, and where the cell provides limited services, including the emergency communication to the UE based on the SIB1 including the cell barred exception IE that indicates the exception for the emergency communication on the barred cell.

A processor (e.g., a standalone processor chipset, or a component of a base station) for wireless communication is described. The processor may be configured to, capable of, or operable to perform one or more operations as described herein. For example, the processor may be configured to, capable of, or operable to transmit, to a UE, a MIB including a cell barred IE for a cell associated with a base station; and transmit, to the UE, a SIB1, where the SIB1 includes a cell barred exception IE that indicates an exception for emergency communication on the barred cell, and where the cell provides limited services, including the emergency communication to the UE based on the SIB1 including the cell barred exception IE that indicates the exception for the emergency communication on the barred cell.

A method performed or performable by a base station for wireless communication is described. The method may include transmitting, to a UE, a MIB including a cell barred IE for a cell associated with the base station; and transmitting, to the UE, a SIB1, where the SIB1 includes a cell barred exception IE that indicates an exception for emergency communication on the barred cell, and where the cell provides limited services, including the emergency communication to the UE based on the SIB1 including the cell barred exception IE that indicates the exception for the emergency communication on the barred cell.

In some implementations of the base station, the processor, and the method described herein, the cell barred exception IE has a Boolean value. In some implementations of the base station, the processor, and the method described herein, the cell barred exception IE is only included in the SIB1.

### BRIEF DESCRIPTION OF THE DRAWINGS

In order to describe the manner in which advantages and features of the disclosure can be obtained, a description of the disclosure is rendered by reference to specific implementations thereof which are illustrated in the appended drawings. These drawings depict only example implementations of the disclosure and are not therefore to be considered to be limiting of its scope. The drawings may have been simplified for clarity and are not necessarily drawn to scale.

FIG. 1 illustrates an example of a wireless communications system in accordance with aspects of the present disclosure.

FIG. 2 illustrates an example flowchart, which provides a determination of camping for emergency calls in a MIB barred cell, in accordance with aspects of the present disclosure.

FIG. 3 illustrates an example of a user equipment (UE) in accordance with aspects of the present disclosure.

FIG. 4 illustrates an example of a processor in accordance with aspects of the present disclosure.

FIG. 5 illustrates an example of a network equipment (NE) in accordance with aspects of the present disclosure.

FIG. 6 illustrates a flowchart of a method performed by a UE in accordance with aspects of the present disclosure.

FIG. 7 illustrates a flowchart of a method performed by an NE in accordance with aspects of the present disclosure.

### DETAILED DESCRIPTION

Lately, some wireless features have been introduced into communication networks including at least some cells of the communication network, which only allow access to UEs, which support that feature. In such a case not only legacy UEs (that do not support this new feature) but also potentially new UEs (specified/developed according to the same 3GPP release as for the new feature) would not be able to access the cell. These UEs are barred using the cellBarred information element (IE) included in the Master Information Block (MIB). This generally prohibits the emergency call establishment from these UEs, which could be detrimental and unfortunate since the cell, even if supporting the new feature, may still be capable of supporting emergency calls. For example, for a new feature of Network Energy Saving (NES), the network must listen to the physical random access channel (PRACH) occasions configured in the cell, as in previous releases. Besides this, once the gNB recognizes there is an emergency call or public safety related service (e.g., multimedia priority service (MPS) or mission critical service (MCS)), the network should ensure that there is no impact to that service (e.g., it may release or deactivate cell discontinuous transmission (DTX)/discontinuous reception (DRX) configuration). So, it would be unfortunate if non-NES UEs (i.e., legacy UEs not supporting NES feature or release 18 UEs not supporting NES feature) cannot make an emergency call while the network is equipped to support it.

In a wireless systemm such as in a 4G Long-Term Evolution (LTE) or a new radio (NR) 5G networks, a “barred cell” refers to a specific cell that a User Equipment (UE) is restricted or prohibited from accessing. The term “barred” implies that the UE is not allowed to connect to or register with the particular cell, even if it is within the coverage area. On such a cell the UE may not even initate an emergency call.

According to third generation partnership project (3GPP), a cell may be categorized according to which service(s) it offers. An “acceptable cell” is a cell on which the UE may camp to obtain limited service (originate emergency calls and receive earthquake and tsunami warning system (ETWS) and commercial mobile alert service (CMAS) notifications). Such a cell shall fulfill the following requirements, which is the minimum set of requirements to initiate an emergency call and to receive ETWS and CMAS notification in an NR network: The cell is not barred, and the cell selection criteria are fulfilled.

For a UE not operating in standalone non-public network (SNPN) Access Mode, a cell is considered as suitable if the following conditions are fulfilled:
The cell is part of either the selected public land mobile network (PLMN) or the registered PLMN or PLMN of the Equivalent PLMN list, and for that PLMN either:
   The PLMN-identification (ID) of that PLMN is broadcast by the cell with no associated closed access group (CAG)-IDs and CAG-only indication in the UE for that PLMN is absent or false;
   Allowed CAG list in the UE for that PLMN includes a CAG-ID broadcast by the cell for that PLMN;
The cell selection criteria are fulfilled.

According to the latest information provided by the non-access stratum (NAS): The cell is not barred. The cell is part of at least one tracking area (TA) that is not part of the list of “Forbidden Tracking Areas for Roaming”, which belongs to a PLMN that fulfils the first bullet above.

For a UE operating in SNPN Access Mode, a cell is considered as suitable if the following conditions are fulfilled: The cell is part of the selected SNPN or the registered SNPN or SNPN of the Equivalent SNPN list of the UE. The cell selection criteria are fulfilled. According to the latest information provided by NAS: The cell is not barred. The cell is part of at least one TA that is not part of the list of “Forbidden Tracking Areas for Roaming” which belongs to the selected SNPN or the registered SNPN or SNPN of the Equivalent SNPN list of the UE.

A cell is barred if it is so indicated in the system information. A cell is reserved if it is so indicated in system information.

Following exception to these definitions are applicable for UEs, if a UE has an ongoing emergency call, all acceptable cells of that PLMN/SNPN are treated as suitable for the duration of the emergency call. A UE camped on a cell that belongs to a tracking area that is forbidden for regional provision of service; a cell that belongs to a tracking area that is forbidden for regional provision service is suitable but provides only limited service. If the UE in radio resource control (RRC)_IDLE fulfils the conditions to support NR sidelink communication/discovery or vehicular connectivity (V2X) sidelink communication in limited service state, the UE may perform NR sidelink communication/discovery or V2X sidelink communication. NOTE: UE is not required to support manual search and selection of PLMN or CAG or SNPN while in RRC CONNECTED state. The UE may use local release of RRC connection to perform manual search if it is not possible to perform the search while RRC connected.

As seen from above, a cell must at least be an “acceptable” cell for a UE to initiate RRC Connection establishment even for emergency calls. A UE therefore may not initiate emergency call from a barred cell.

In 5G, a cell is barred using cellBarred IE included in the Master Information Block (MIB). A MIB content is shown below:

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}

One potential solution would be to rely on a UE's reselection mobility and hope that the reselected cell provides access to the UE, i.e. does not support any feature that mandates barring in the MIB. However this is not optimal since some UEs may not find a cell for reselection or find a cell for which the cell selection criteria (defined below) are not fulfilled.

Cell Selection Criterion: The cell selection criterion S is fulfilled when:

$$Srxlev > 0 AND Squal > 0$$

$$where :$$

$$Srxlev = {Q}_{rxlevmeas} - ( {Q}_{rxlevmin} + {Q}_{rxlevminoffset} ) - {P}_{compensation} - {Qoffset}_{temp}$$

$$Squal = {Q}_{qualmeas} - ( {Q}_{qualmin} + {Q}_{qualminoffset} ) - {Qoffset}_{temp}$$

where:

| | |
|---|---|
| Srxlev | Cell selection receive (RX) level value decibels (dB) |
| Squal | Cell selection quality value (dB) |
| Qoffsetₜₑₘₚ | Offset temporarily applied to a cell as specified in TS 38.331 (dB) |
| Qᵣₓₗₑᵥₘₑₐₛ | Measured cell RX level value reference signal receive power (RSRP) |
| Q_{qualmeas} | Measured cell quality value reference signal received quality (RSRQ) |
| Qᵣₓₗₑᵥₘᵢₙ | Minimum required RX level in the cell (dBm). If the UE supports |
| | supplementary uplink (SUL) frequency for this cell, Qᵣₓₗₑᵥₘᵢₙ is |
| | obtained from q-RxLevMinSUL, if present, in SIB1, SIB2 and SIB4, |
| | additionally, if Q_{rxlevminoffsetcellSUL} is present in SIB3 and SIB4 for the |
| | concerned cell, this cell specific offset is added to the corresponding |
| | Qrxlevmin to achieve the required minimum RX level in the |
| | concerned cell; |
| | else Qᵣₓₗₑᵥₘᵢₙ is obtained from q-RxLevMin in SIB1, SIB2 and SIB4, |
| | additionally, if Q_{rxlevminoffsetcell} is present in SIB3 and SIB4 for the |
| | concerned cell, this cell specific offset is added to the corresponding |
| | Qrxlevmin to achieve the required minimum RX level in the |
| | concerned cell. |
| Q_{qualmin} | Minimum required quality level in the cell (dB). Additionally, if |
| | Q_{qualminoffsetcell} is signalled for the concerned cell, this cell specific |
| | offset is added to achieve the required minimum quality level in the |
| | concerned cell. |
| Q_{rxlevminoffset} | Offset to the signalled Qᵣₓₗₑᵥₘᵢₙ taken into account in the Srxlev |
| | evaluation as a result of a periodic search for a higher priority PLMN |
| | while camped normally in a visiting (V)PLMN, as specified in TS |
| | 23.122. |
| Q_{qualminoffset} | Offset to the signalled Q_{qualmin} taken into account in the Squal |
| | evaluation as a result of a periodic search for a higher priority PLMN |
| | while camped normally in a VPLMN, as specified in TS 23.122. |
| P_{compensation} | For frequency range 1 (FR1), if the UE supports the additionalPmax |
| | in the NR-NS-PmaxList, if present, in SIB1, SIB2 and SIB4: |
| | max(P_{EMAX1} − P_{PowerClass}, 0) − (min(P_{EMAX2}, P_{PowerClass}) − min (P_{EMAX1}, |
| | P_{PowerClass})) (dB); |
| | else: |
| | max(P_{EMAX1} − P_{PowerClass}, 0) (dB) |
| | For frequency range 2 (FR2), P_{compensation} is set to 0. |
| | For integrated access backhaul-mobile terminal (IAB-MT), |
| | P_{compensation} is set to 0. |
| P_{EMAX1}, P_{EMAX2} | Maximum transmit (TX) power level of a UE may use when |
| | transmitting on the uplink in the cell (dBm) defined as P_{EMAX} in TS |
| | 38.101. If UE supports SUL frequency for this cell, P_{EMAX1} and |
| | P_{EMAX2} are obtained from the p-Max for SUL in SIB1 and NR-NS- |
| | PmaxList for SUL respectively in SIB1, SIB2 and SIB4 as specified in |
| | TS 38.331, else P_{EMAX1} and P_{EMAX2} are obtained from the p-Max and |
| | NR-NS-PmaxList respectively in SIB1, SIB2 and SIB4 for normal UL |
| | as specified in TS 38.331. |
| P_{PowerClass} | Maximum RF output power of the UE (dBm) according to the UE |
| | power class as defined in TS 38.101-1. |

The signaled values Q_{rxlevminoffset} and Q_{qualminoffset} may only be applied when a cell is evaluated for cell selection as a result of a periodic search for a higher priority PLMN while camped normally in a VPLMN. During this periodic search for higher priority PLMN, the UE may check the S criteria of a cell using parameter values stored from a different cell of this higher priority PLMN.

Aspects of the present disclosure are described in the context of a wireless communications system. In the wireless communications system, a UE and an NE (e.g., a base station, gNB, network entity, network node) may support wireless communication, including reception and/or transmission of wireless communication using time-frequency resources. For example, the UE and the NE may support communicating signals (e.g., carrying control information, data, or the like). It should be understood that various terms may be used interchangeably with “communicating,” such as “signaling,” “transmitting,” “receiving,” “outputting,” “forwarding,” “relaying,” “retrieving,” “obtaining,” and so forth.

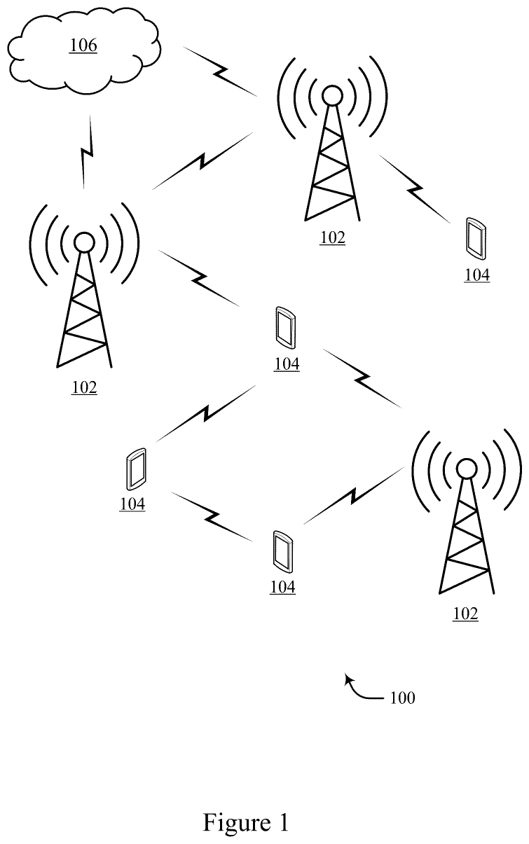

FIG. 1 illustrates an example of a wireless communications system 100 in accordance with aspects of the present disclosure. The wireless communications system 100 may include one or more NE 102, one or more device 104, and a network 106. The wireless communications system 100 may support various radio access technologies. In some implementations, the wireless communications system 100 may be a fourth generation (4G) network, such as a long-term evolution (LTE) network or an LTE-Advanced (LTE-A) network. In some other implementations, the wireless communications system 100 may be a new radio (NR) network, such as a fifth generation (5G) network, a 5G-Advanced (5G-A) network, or a 5G ultrawideband (5G-UWB) network. In other implementations, the wireless communications system 100 may be one of, or a combination of, a 4G network, a 5G network, a Third Generation Partnership Project (3GPP)-based network, one or more of a future generation network (6G, etc.), and/or one or more of any other suitable radio access technology, wireless access technology, and/or wired access technology, including Institute of Electrical and Electronics Engineers (IEEE) 802.11 (Wi-Fi), IEEE 802.16 (WiMAX), and/or IEEE 802.20, a Wireless Local Area Network (WLAN), a satellite communication network, a high-altitude platform network, the Internet, and/or other communication networks. The wireless communications system 100 may support radio access technologies beyond 5G, for example, 6G. Additionally, the wireless communications system 100 may support various multiple access technologies, such as time division multiple access (TDMA), frequency division multiple access (FDMA), code division multiple access (CDMA), orthogonal frequency division multiple access (OFDMA), etc.

The one or more NE 102 may be dispersed throughout a geographic region to form the wireless communications system 100. One or more of the NE 102 described herein may be or include or may be referred to as a network node, a base station, a network element, a network function, a network entity, a network node, network infrastructure, a radio access network (RAN), a NodeB, an eNodeB (eNB), a next-generation NodeB (gNB), an access point, a transmission-reception point (TRP), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or Machine-Type Communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the network 106, or with another NE 102, or both. For example, an NE 102 may interface with another NE 102 or the network 106 through one or more backhaul links (e.g., S1, N2, N2, or network interface). In some implementations, the NE 102 may communicate with each other directly. In some other implementations, the NE 102 may communicate with each other or indirectly (e.g., via the network 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or TRPs.

The network 106 may support user authentication, access authorization, tracking, connectivity, and other access, routing, or mobility functions. The network 106 may be an evolved packet core (EPC), or a 5GC, which may include a control plane entity that manages access and mobility (e.g., a Mobility Management Entity (MME), an Access and Mobility Management Function (AMF)) and a user plane entity that routes packets or interconnects to external networks (e.g., a Serving Gateway (S-GW), a Packet Data Network (PDN) Gateway (P-GW), or a User Plane Function (UPF)). In some implementations, the control plane entity may manage Non-Access Stratum (NAS) functions, such as mobility, authentication, and bearer management (e.g., data bearers, signal bearers, etc.) for the one or more UEs 104 served by the one or more NE 102 associated with the network 106.

The network 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a Protocol Data Unit (PDU) session, or the like) with the network 106 via an NE 102. The network 106 may route traffic (e.g., control information, data, and the like) between the UE 104 and the application server using the established session (e.g., the established PDU session). The PDU session may be an example of a logical connection between the UE 104 and the network 106 (e.g., one or more network functions of the network 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an Electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHZ-24.25 GHz), FR4 (52.6 GHz-114.25 GHz), FR4a or FR4-1 (52.6 GHZ-71 GHZ), and FR5 (114.25 GHZ-300 GHz). In some implementations, the NEs 102 and the UE 104 may perform wireless communications over one or more of the operating frequency bands. In some implementations, FR1 may be used by the NEs 102 and the UEs 104, among other equipment or devices for cellular communications traffic (e.g., control information, data, etc.). For example, communication traffic can include user data, control information, and other communication traffic. The control information can be used for establishing and controlling communications that transmit and receive the user data, such as in packets, in physical shared channels, in data regions of subframes, and in other communications. In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

For the purpose of this document an emergency call can be Internet protocol Multimedia Subsystem (IMS) based emergency call or non-IMS based e.g., using the 3GPP infrastructure only. The implementations revealed herein equally apply to a public safety related service (e.g., MPS or MCS), and an “emergency call” in this document is used to refer to any/all of these.

There are at least two mechanisms which allow an operator to impose cell reservations or access restrictions. The first mechanism uses an indication of cell status and special reservations for control of cell selection and reselection procedures. The second mechanism, referred to as Unified Access Control, shall allow the prevention of selected access categories or access identities from sending initial access messages for load control reasons.

Cell status and cell reservations are indicated in the MIB or SIB1 message by means of following fields:
cellBarred (IE type: “barred” or “not barred”)
Indicated in MIB message. In case of multiple PLMNs or NPNs indicated in SIB1, this field is common for all PLMNs and NPNs. This field is ignored by UEs supporting NTN while cellBarredNTN is included in SIB1.
cellBarredATG (IE type: “barred” or “not barred”)
Indicated in SIB1 message. In case of multiple PLMNs or NPNs indicated in SIB1, this field is common for all PLMNs and NPNs. This field is only applicable to air to ground (ATG) UEs.
cellBarred-eRedCap1Rx (IE type: “barred” or “not barred”)
Indicated in SIB1 message. In case of multiple PLMNs or NPNs indicated in SIB1, this field is common for all PLMNs and NPNs. This field is only applicable to eRedCap UEs.
cellBarred-eRedCap2Rx (IE type: “barred” or “not barred”)
Indicated in SIB1 message. In case of multiple PLMNs or NPNs indicated in SIB1, this field is common for all PLMNs and NPNs. This field is only applicable to eRedCap UEs.
cellBarredNES (IE type: “not barred”)
Indicated in SIB1 message. In case of multiple PLMNs or NPNs indicated in SIB1, this field is common for all PLMNs and NPNs. This field is only applicable to UEs capable of NES cell DTX/DRX.
cellBarredNTN (IE type: “barred” or “not barred”)
Indicated in SIB1 message. In case of multiple PLMNs indicated in SIB1, this field is common for all PLMNs. This field is ignored if the UE does not support NTN connectivity.
cellBarredRedCap1Rx (IE type: “barred” or “not barred”)
Indicated in SIB1 message. In case of multiple PLMNs or NPNs indicated in SIB1, this field is common for all PLMNs and NPNs. This field is only applicable to RedCap UEs.
cellBarredRedCap2Rx (IE type: “barred” or “not barred”)
Indicated in SIB1 message. In case of multiple PLMNs or NPNs indicated in SIB1, this field is common for all PLMNs and NPNs. This field is only applicable to RedCap UEs.
cellReservedForOperator Use (IE type: “reserved” or “not reserved”)
Indicated in SIB1 message. In case of multiple PLMNs or NPNs indicated in SIB1, this field is specified per PLMN or per SNPN.
cellReservedForOtherUse (IE type: “true”)
Indicated in SIB1 message. In case of multiple PLMNs indicated in SIB1, this field is common for all PLMNs.
cellReservedForFutureUse (IE type: “true”)
Indicated in SIB1 message. In case of multiple PLMNs or NPNs indicated in SIB1, this field is common for all PLMNs and NPNs.
NOTE 0: IAB-MT ignores the cellBarred, cellReservedForOperator Use, cellReservedForFutureUse, and intraFreqReselection (i.e. treats intraFreqReselection as if it was set to allowed) as defined in TS 38.331. IAB-MT also ignores cellReservedForOtherUse for cell barring determination (i.e. NPN capable IAB-MT considers cellReservedForOtherUse for determination of an NPN-only cell).
NOTE 0a: NCR-MT ignores the cellBarred, cellReservedForOperatorUse, cellReservedForFutureUse, and intraFreqReselection (i.e. treats intraFreqReselection as if it was set to allowed) as defined in TS 38.331. NCR-MT also ignores cellReservedForOtherUse for cell barring determination (i.e. NPN capable NCR-MT considers cellReservedForOtherUse for determination of an NPN-only cell).
   halfDuplexRedCapAllowed (IE type: “true”)
   Indicated in SIB1 message. In case of multiple PLMNs or NPNs indicated in SIB1, this field is common for all PLMNs and NPNs. This field is only applicable to (e) RedCap UEs.
   iab-Support (IE type: “true”)
   Indicated in SIB1 message. In case of multiple PLMNs or NPNs indicated in SIB1, this field is specified per PLMN or per SNPN.
   ncr-Support (IE type: “true”)
   Indicated in SIB1 message. In case of multiple PLMNs or NPNs indicated in SIB1, this field is common for all PLMNs and NPNs.
   mobileIAB-Support (IE type: “true”)
   Indicated in SIB1 message. In case of multiple PLMNs or NPNs indicated in SIB1, this field is specified per PLMN or per SNPN.

When the cell status is indicated as “not barred” and “not reserved” for operator use and not “true” for other use and not “true” for future use, UEs shall treat this cell as candidate during the cell selection and cell reselection procedures.

When the cell broadcasts any CAG-IDs or NIDs and the cell status is indicated as “not barred” and “not reserved” for operator use and “true” for other use, and not “true” for future use: All NPN-capable UEs shall treat this cell as candidate during the cell selection and cell reselection procedures, other UEs shall treat this cell as if cell status is “barred”.

When cell status is indicated as “true” for other use, and either cell does not broadcast any CAG-IDs or NIDs or does not broadcast any CAG-IDs and the UE is not operating in SNPN Access Mode, the UE shall treat this cell as if cell status is “barred”.

When cell status is indicated as “true” for future use, the UE shall treat this cell as if cell status is “barred”.

When cellBarredNES is absent and cellBarred is set to “barred”, the UE capable of NES cell DTX/DRX shall treat this cell as if cell status is “barred”.

When cellBarredNTN is not broadcast in this cell, for NTN access, the UE shall treat this cell as if cell status is “barred”.

When halfDuplexRedCapAllowed is not broadcast in this cell, the (e) RedCap UE only capable of operating in half-duplex for frequency division duplex (FDD) shall treat this cell as if cell status is “barred”.

When cellBarredATG is not broadcast in this cell, for ATG access, the UE shall treat this cell as if cell status is “barred”.

When cell status is indicated as “not barred” and “reserved” for operator use for any PLMN/SNPN and not “true” for other use and not “true” for future use,
UEs assigned to Access Identity 11 or 15 operating in their home (H)PLMN/equivalent (E)HPLMN shall treat this cell as candidate during the cell selection and reselection procedures if the field cellReservedForOperatorUse for that PLMN set to “reserved”.
UEs assigned to Access Identity 11 or 15 shall treat this cell as candidate during the cell selection and reselection procedures if the field cellReservedForOperator Use for selected/registered SNPN is set to “reserved”.
UEs assigned to an Access Identity 0, 1, 2 and 12 to 14 shall behave as if the cell status is “barred” in case the cell is “reserved for operator use” for the registered PLMN/SNPN or the selected PLMN/SNPN.
UEs assigned to Access Identity 3 shall behave as if the cell status is “barred” in case the cell is “reserved for operator use” for the registered PLMN or the selected PLMN.
NOTE 1: Access Identities 11, 15 are only valid for use in the HPLMN/EHPLMN and registered/selected SNPN; Access Identities 12, 13, 14 are only valid for use in the home country and registered/selected SNPN.
NOTE 1a: Access Identity 3 is only valid for PLMNs that indicate to potential Disaster Inbound Roamers that the UEs can access the PLMN.

When cell status “barred” is indicated or to be treated as if the cell status is “barred”,
The UE is not permitted to select/reselect this cell, not even for emergency calls.
The UE shall select another cell according to the following rule:
If the cell is to be treated as if the cell status is “barred” due to being unable to acquire the MIB:
   the UE may exclude the barred cell as a candidate for cell selection/reselection for up to 300 seconds.
   the UE may select another cell on the same frequency if the selection criteria are fulfilled.
else:
   If the UE is a RedCap UE, the UE shall acquire SIB1 and, in the remainder of this procedure, consider ‘intraFreqReselection in MIB’ to be ‘intraFreqReselectionRedCap in SIB1’, if available;
   If the UE is an eRedCap UE, the UE shall acquire SIB1 and, in the remainder of this procedure, consider ‘intraFreqReselection in MIB’ to be ‘intraFreqReselection-eRedCap in SIB1’, if available.
      If the cell is to be treated as if the cell status is “barred” due to being unable to acquire the SIB1:
         the UE may exclude the barred cell as a candidate for cell selection/reselection for up to 300 seconds.
         the UE may select another cell on the same frequency if the selection criteria are fulfilled.
      If the cell status “barred” is indicated in MIB but the UE is unable to acquire the SIB1; or
      If the cell is to be treated as if the cell status is “barred” due to not supporting (e) RedCap UEs:
         the UE shall exclude the barred cell as a candidate for cell selection/reselection for 300 seconds.
         the UE may select another cell on the same frequency if re-selection criteria are fulfilled.
      If the UE is neither a RedCap UE nor an eRedCap UE, or if the UE is a RedCap UE and intraFreqReselectionRedCap in SIB1 is available, or if the UE is an eRedCap UE and intraFreqReselection-eRedCap in SIB1 is available:
         If the field intraFreqReselection in MIB message is set to “allowed”:
         the UE may select another cell on the same frequency if re-selection criteria are fulfilled;
         If the cell is to be treated as if the cell status is “barred” due to being unable to acquire the SIB1:
         the UE may exclude the barred cell as a candidate for cell selection/reselection for up to 300 seconds;
         else:
         the UE shall exclude the barred cell as a candidate for cell selection/reselection for 300 seconds.
      If the field intraFreqReselection in MIB message is set to “not allowed”:
         If the cell is to be treated as if the cell status is “barred” due to being unable to acquire the SIB1:
         the UE may exclude the barred cell as a candidate for cell selection/reselection for up to 300 seconds;
         If the cell operates in licensed spectrum:
         the UE shall not re-select to another cell on the same frequency as the barred cell and exclude such cell(s) as candidate(s) for cell selection/reselection for 300 seconds;
         else:
         the UE may select to another cell on the same frequency if the reselection criteria are fulfilled.
         else:
         If the cell operates in licensed spectrum, or if this cell belongs to a PLMN which is indicated as being equivalent to the registered PLMN or the selected PLMN of the UE, or if this cell belongs to an SNPN which is equal to or indicated as being equivalent to the registered SNPN or the selected SNPN of the UE:
         the UE shall not re-select to another cell on the same frequency as the barred cell and exclude such cell(s) as candidate(s) for cell selection/reselection for 300 seconds;
         else:
         the UE may select to another cell on the same frequency if the reselection criteria are fulfilled.
         the UE shall exclude the barred cell as a candidate for cell selection/reselection for 300 seconds.

The cell selection of another cell may also include a change of RAT. NOTE 2: If barring of a cell is triggered by the condition of trackingAreaCode and trackingAreaList not being provided, the barring only applies to this PLMN and the UE can re-evaluate the barring condition again due to selection of another PLMN.

Above features are listed as mere examples, the solutions revealed henceforth shall equally apply to features not yet specified enabling the future-feature non-supporting UEs to make emergency call.

For addressing above noted concerns, and based on the explained background information, the following implementations are presented:

In at least a first implementation, a new IE can be added in SIB1. The new IE can be a Boolean IE and, as an example, can be called Allow-Emergency-and-PS. If the Allow-Emergency-and-PS is set to True, a UE may consider this cell as an acceptable cell, provided the cell selection criteria are met, and may initiate emergency calls.

Alternatively, this IE may only be broadcasted in SIB1 when cellBarred IE in MIB is set to “Barred”. The IE can only take one value “allowed” when broadcasted. When broadcasted, any UE may consider this cell as an acceptable cell, provided the cell selection criteria are met, and may initiate emergency calls.

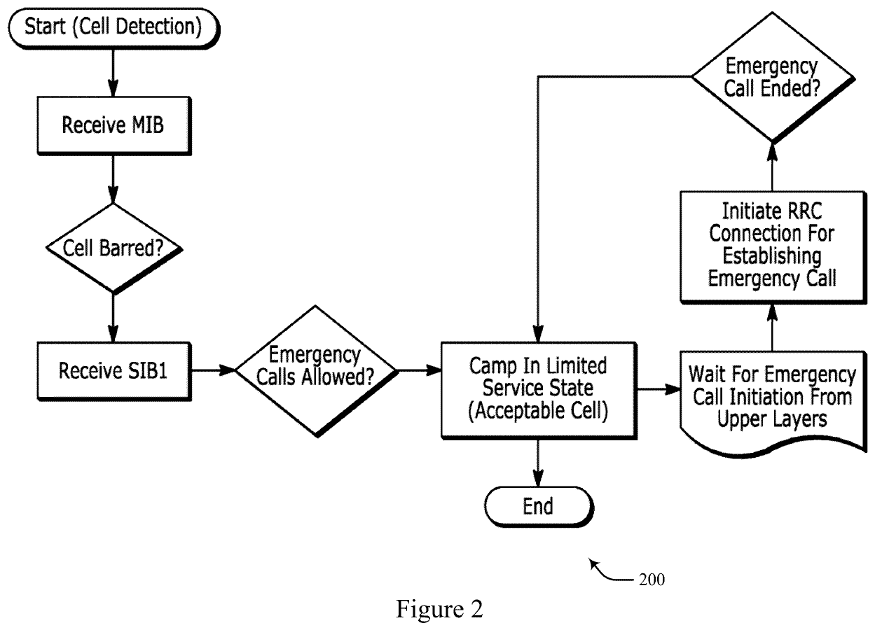

FIG. 2 illustrates an example flowchart 200, which provides a determination of camping for emergency calls in a MIB barred cell.

In one example, the IE Allow-Emergency-and-PS may apply to a supported feature when the UE is not intending to use that feature. To clarify with a specific example, a non-terrestrial network (NTN) capable UE may not intend to access a cell for NTN access, and therefore if a barring is done using MIB/SIB1 (cellBarredNTN is not broadcast), the NTN capable UE not accessing the cell for NTN purpose may consider itself to be barred. In such a case, the IE Allow-Emergency-and-PS can alleviate this problem and allow the NTN capable UE not accessing the cell for NTN to camp there as an acceptable cell, and initiate emergency calls, when appropriate.

In some instances it may be possible to have a positive and negative list of features that are affected by the Allow-Emergency-and-PS flag. For example, either: Emergency called Allowed List: Feature-x, Feature-y, Feature-z; or Emergency called Allowed List: Feature-1, Feature-2, Feature-3.

Such a list could be broadcasted in the SIB1.

In at least a further implementation, an already available IE in SIB1 can be repurposed. For example, non-NES UEs may still receive and interpret cellBarredNES in the sense that when broadcasted, an emergency call establishment is allowed/supported in the cell, when cellBarred IE in MIB is set to “Barred”.

In another example, when one of cellBarredATG, cellBarred-eRedCap1Rx, cellBarred-eRedCap2Rx, cellBarredNTN, cellBarredRedCap1Rx etc. is set to “not barred”, non-feature specific UEs may still receive and interpret the IE in the sense that an emergency call establishment is allowed/supported in the cell, when cellBarred IE in MIB is set to “Barred”.

In at least a still further implementation, an already available IE in SIB1 is repurposed. For example, non-NES UEs may still receive and interpret ims-Emergency Support/eCallSupport in the sense that when broadcasted/set to ‘true’, an emergency call establishment is allowed/supported in the cell, when cellBarred IE in MIB is set to “Barred”.

In at least a still further implementation, a new list of features is broadcasted in SIB1 when cellBarred IE in MIB is set to “Barred” and ‘intraFreqReselection in MIB is set to ‘notAllowed’. The listed features are those for which intra frequency reselection is allowed (or alternatively, not allowed).

Correspondingly, in the present application, apparatus and methods are described, which can allow emergency and public safety (MPS or MCS) calls. Such apparatus and/or methods can use a new IE (Boolean in SIB1), which may be always broadcasted, or conditionally broadcasted. Alternatively, such an apparatus and/or method could repurpose an existing feature-barring IE(s) in SIB1. Further, an existing IE ims-EmergencySupport in SIB1 could also be repurposed. Furthermore, an intra frequency reselection could be enabled/disabled, such as for one or more specific features in SIB1.

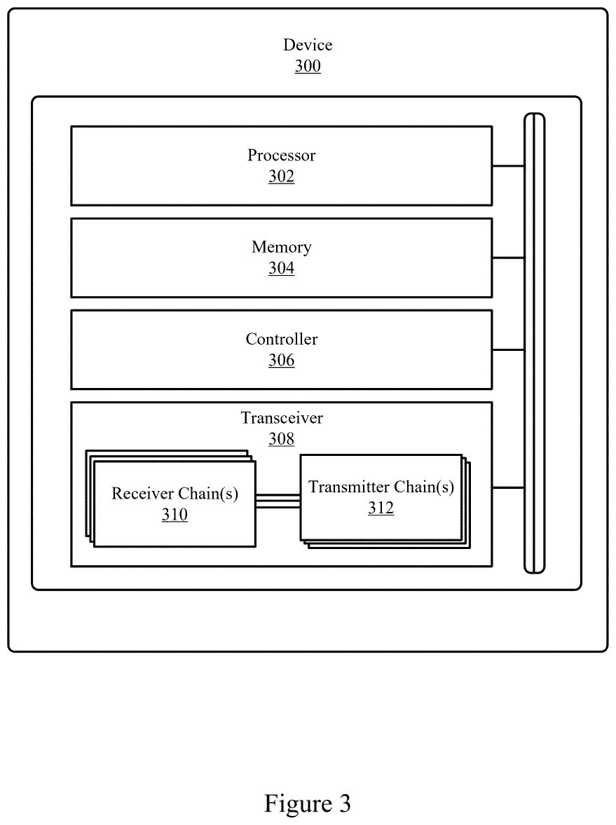

FIG. 3 illustrates an example of a UE 300, in accordance with aspects of the present disclosure. The UE 300 may include at least one processor 302, at least one memory 304, at least one controller 306, and at least one transceiver 308. The processor 302, the memory 304, the controller 306, the transceiver 308, various combinations thereof, or various components thereof may be examples of means for performing various aspects of the present disclosure as described herein. These components may be coupled (e.g., operatively, communicatively, functionally, electronically, electrically) via one or more interfaces.

The processor 302, the memory 304, the controller 306, the transceiver 308, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 302 may include an intelligent hardware device (e.g., a general-purpose processor, a DSP, a central processing unit (CPU), an ASIC, a field programmable gate array (FPGA), or any combination thereof). In some implementations, the processor 302 may be configured to operate the memory 304. In some other implementations, the memory 304 may be integrated into the processor 302. The processor 302 may be configured to execute computer-readable instructions stored in the memory 304 to cause the UE 300 to perform various functions of the present disclosure.

The memory 304 may include volatile or non-volatile memory. The memory 304 may store computer-readable, computer-executable code including instructions when executed by the processor 302 to cause the UE 300 to perform various functions described herein. The code may be stored in a non-transitory computer-readable medium such the memory 304 or another type of memory. Computer-readable media includes both non-transitory computer storage media and communication media including any medium that facilitates the transfer of a computer program from one place to another. A non-transitory storage medium may be any available medium that may be accessed by a general-purpose or special-purpose computer.

The controller 306 may manage input and output signals for the UE 300. The controller 306 may also manage peripherals not integrated into the UE 300. In some implementations, the controller 306 may utilize an operating system such as iOS®, ANDROID®, WINDOWS®, or other operating systems. In some implementations, the controller 306 may be implemented as part of the processor 302.

In some implementations, the UE 300 may include at least one transceiver 308. In some other implementations, the UE 300 may have more than one transceiver 308. The transceiver 308 may represent a wireless transceiver. The transceiver 308 may also represent and/or include one or more other wireless and/or wired communication interfaces, such as a network interface, a universal serial bus (USB) port, on optical transceiver, and/or any other transceiver, interface, port, communication interface, etc. The transceiver 308 may include one or more receiver chains 310, one or more transmitter chains 312, or a combination thereof.

A receiver chain 310 may be configured to receive signals (e.g., control information, data, packets) over a wireless medium. For example, the receiver chain 310 may include one or more antennas to receive the signal over the air or wireless medium. The receiver chain 310 may include at least one amplifier (e.g., a Low-Noise Amplifier (LNA)) configured to amplify the received signal. The receiver chain 310 may include at least one demodulator configured to demodulate the received signal and obtain the transmitted data by reversing the modulation technique applied during transmission of the signal. The receiver chain 310 may include at least one decoder for decoding the processing the demodulated signal to receive the transmitted data.

A transmitter chain 312 may be configured to generate and transmit signals (e.g., control information, data, packets). The transmitter chain 312 may include at least one modulator for modulating data onto a carrier signal, preparing the signal for transmission over a wireless medium. The at least one modulator may be configured to support one or more modulation techniques such as Amplitude Modulation (AM), Frequency Modulation (FM), digital modulation schemes like Phase-Shift Keying (PSK) or Quadrature Amplitude Modulation (QAM), and/or any other modulation techniques. The transmitter chain 312 may also include at least one power amplifier configured to amplify the modulated signal to an appropriate power level suitable for transmission over the wireless medium. The transmitter chain 312 may also include one or more antennas for transmitting the amplified signal into the air or wireless medium.

In some implementations, the processor 302 and the memory 304 coupled with the processor 302 may be configured to cause the UE 300 to perform one or more of the functions described herein (e.g., executing, by the processor 302, instructions stored in the memory 304). For example, the processor 302 may support wireless communication at the UE 300 in accordance with the examples as disclosed herein.

The UE 300 may be configured to support the enabling of emergency calls and public safety services support. More specifically, the UE 300 may be configured to support a means for receiving a Master Information Block (MIB) including cell access status information including a potential indication of a status of barred from a first base station, and receiving a System Information Block Type 1 (SIB1) from the first base station. A determination can then be made as to whether the MIB indicates a UE cell access status of barred for a cell associated with the first base station. In response to determining that the cell access status information indicates a barred status for the cell associated with the first base station, a determination can be made as to whether the SIB1 includes an Information Element (IE) that indicates a barred cell status exception for emergency information messaging. In response to determining that the SIB1 includes an IE that indicates a barred cell status exception for emergency information messaging, an active cell selection for the cell associated with the first base station can be established for at least a limited purpose of supporting emergency information messaging.

According to a possible implementation, the establishing an active cell selection includes camping on the cell to obtain limited services including the support of emergency information messaging. According to a further possible implementation, support of emergency information messaging includes originating emergency calls, and receiving Earthquake and Tsunami Warning System (ETWS) and Commercial Mobile Alert Service (CMAS) notifications. According to a still further implementation, the IE, that indicates the barred cell status exception for emergency information messaging is an Allow-Emergency-and-PS IE, which has a boolean value, which when set to true, enables a UE to consider this cell as an acceptable cell for purposes of supporting emergency information messaging.

According to a possible implementation, the IE that indicates a barred cell status exception is only included in the SIB1, when the MIB includes an indication of a UE cell access status of barred. According to a further implementation, the IE that indicates a barred cell status exception is a new IE established for providing the barred cell status exception. According to a still further implementation, the IE that indicates a barred cell status exception is an already available IE, which is repurposed for providing the barred cell status exception, when it is included as part of the SIB1.

According to a possible implementation, a non-Network Energy Savings UE can receive a repurposed cellBarredNES IE for indicating a barred cell status exception. According to a further implementation, a non-Network Energy Savings UE can receive a repurposed ims-Emergency Support IE for indicating a barred cell status exception.

In some instances, a broadcast of the SIB1 includes a new list of features which are either allowed or not allowed for intra frequency reselection, when the cell access status information indicates a barred status for the cell associated with the first base station, and an intra frequency reselection status in the MIB is set to not allowed.

In some implementations, the processor 302 and the memory 304 coupled with the processor 302 may be configured to or operable to cause the UE 300 to perform one or more of the functions described herein (e.g., executing, by the processor 302, instructions stored in the memory 304). For example, the processor 302 may support wireless communication at the UE 300 in accordance with examples as disclosed herein. The UE 300 may be configured to or operable to support a means for receiving a MIB including a cell barred IE; receiving a SIB1; determining whether the MIB indicates that the UE is barred for a cell; in response to the UE being barred for the cell, determining whether the SIB1 includes a cell barred exception IE that indicates an exception for emergency communication on the barred cell; and in response to the SIB1 including the cell barred exception IE, assigning the cell as an acceptable cell for the UE to camp for limited services, including the emergency communication.

Additionally, the UE 300 may be configured to or operable to support any one or combination of the method further including camping on the cell for the limited services, including the emergency communication. The cell barred exception IE has a Boolean value. The method further including assigning the cell as the acceptable cell for the UE to camp for the limited services based on the Boolean value of true. The cell barred exception IE is only included in the SIB1.

Additionally, or alternatively, the UE 300 may support at least one memory (e.g., the memory 304) and at least one processor (e.g., the processor 302) coupled with the at least one memory and configured to or operable to cause the UE to receive a MIB including a cell barred IE; receive a SIB1; determine whether the MIB indicates that the UE is barred for a cell; in response to the UE being barred for the cell, determine whether the SIB1 includes a cell barred exception IE that indicates an exception for emergency communication on the barred cell; and in response to the SIB1 including the cell barred exception IE, assign the cell as an acceptable cell for the UE to camp for limited services, including the emergency communication.

Additionally, the UE 300 may be configured to or operable to support any one or combination of the at least one processor is operable to cause the UE to camp on the cell for the limited services, including the emergency communication. The cell barred exception IE has a Boolean value. The at least one processor is operable to cause the UE to assign the cell as the acceptable cell for the UE to camp for the limited services based on the Boolean value of true. The cell barred exception IE is only included in the SIB1.

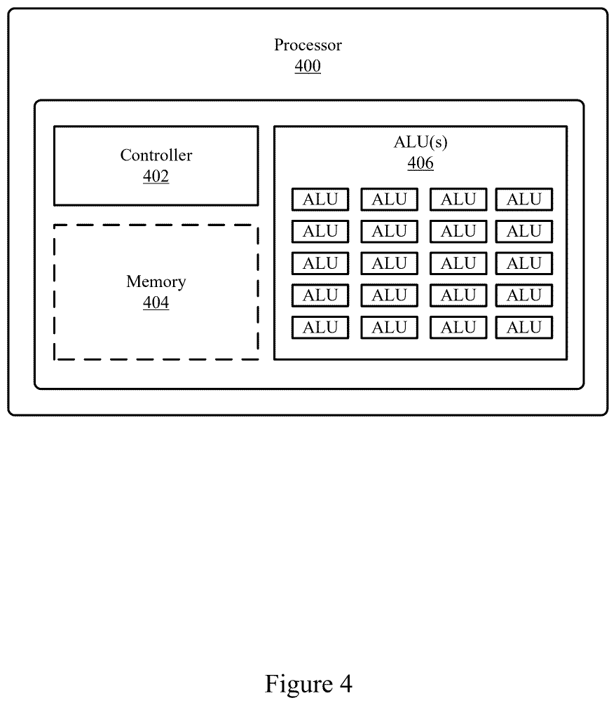

FIG. 4 illustrates an example of a processor 400 in accordance with aspects of the present disclosure. The processor 400 may be an example of a processor configured to perform various operations in accordance with the examples described herein. The processor 400 may include at least one controller 402 configured to perform various operations in accordance with the examples described herein. The processor 400 may optionally include at least one memory 404, which may be, for example, an L1/L2/L3 cache. Additionally, or alternatively, the processor 400 may optionally include one or more arithmetic-logic units (ALUs) 406. One or more of these components may be in electronic communication or otherwise coupled (e.g., operatively, communicatively, functionally, electronically, electrically) via one or more interfaces (e.g., buses).

The processor 400 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 400)) or other memory (e.g., Random Access Memory (RAM), Read-Only Memory (ROM), Dynamic RAM (DRAM), Synchronous DRAM (SDRAM), Static RAM (SRAM), Ferroelectric RAM (FeRAM), Magnetic RAM (MRAM), Resistive RAM (RRAM), flash memory, Phase Change Memory (PCM), and others).

The controller 402 may be configured to manage and coordinate various operations (e.g., signaling, receiving, obtaining, retrieving, transmitting, outputting, forwarding, storing, determining, identifying, accessing, writing, and reading) of the processor 400 to cause the processor 400 to support various operations in accordance with examples as described herein. For example, the controller 402 may operate as a control unit of the processor 400, generating control signals that manage the operation of various components of the processor 400. These control signals include enabling or disabling functional units, selecting data paths, initiating memory access, and coordinating the timing of operations.

The controller 402 may be configured to fetch (e.g., obtain, retrieve, receive) instructions from the memory 404 and determine subsequent instruction(s) to be executed to cause the processor 400 to support various operations in accordance with examples as described herein. The controller 402 may be configured to track memory addresses of instructions associated with the memory 404. The controller 402 may be configured to decode instructions to determine the operation to be performed and the operands involved. For example, the controller 402 may be configured to interpret the instruction and determine control signals to be output to other components of the processor 400 to cause the processor 400 to support various operations in accordance with examples as described herein. Additionally, or alternatively, the controller 402 may be configured to manage the flow of data within the processor 400. The controller 402 may be configured to control the transfer of data between registers, ALUs, and other functional units of the processor 400.

The memory 404 may include one or more caches (e.g., memory local to or included in the processor 400 or other memory, such RAM, ROM, DRAM, SDRAM, SRAM, MRAM, flash memory, etc. In some implementations, the memory 404 may reside within or on a processor chipset (e.g., local to the processor 400). In some other implementations, the memory 404 may reside external to the processor chipset (e.g., remote to the processor 400).

The memory 404 may store computer-readable, computer-executable code including instructions that, when executed by the processor 400, cause the processor 400 to perform various functions described herein. The code may be stored in a non-transitory computer-readable medium such as system memory or another type of memory. The controller 402 and/or the processor 400 may be configured to execute computer-readable instructions stored in the memory 404 to cause the processor 400 to perform various functions. For example, the processor 400 and/or the controller 402 may be coupled with or to the memory 404, the processor 400, the controller 402, and the memory 404 may be configured to perform various functions described herein. In some examples, the processor 400 may include multiple processors and the memory 404 may include multiple memories. One or more of the multiple processors may be coupled with one or more of the multiple memories, which may, individually or collectively, be configured to perform various functions herein.

The one or more ALUs 406 may be configured to support various operations in accordance with examples as described herein. In some implementations, the one or more ALUs 406 may reside within or on a processor chipset (e.g., the processor 400). In some other implementations, the one or more ALUs 406 may reside external to the processor chipset (e.g., the processor 400). One or more ALUs 406 may perform one or more computations such as addition, subtraction, multiplication, and division on data. For example, one or more ALUs 406 may receive input operands and an operation code, which determines an operation to be executed. One or more ALUs 406 be configured with a variety of logical and arithmetic circuits, including adders, subtractors, shifters, and logic gates, to process and manipulate the data according to the operation. Additionally, or alternatively, the one or more ALUs 406 may support logical operations such as AND, OR, exclusive-OR (XOR), not-OR (NOR), and not-AND (NAND), enabling the one or more ALUs 406 to handle conditional operations, comparisons, and bitwise operations.

The processor 400 may support wireless communication in accordance with examples as disclosed herein. According to a possible implementation relating to a UE, the at least one controller 402 can be configured to cause the processor 400 to receive a Master Information Block (MIB) including cell access status information including a potential indication of a status of barred from a first base station, and receive a System Information Block Type 1 (SIB1) from the first base station. A determination can then be made as to whether the MIB indicates a UE cell access status of barred for a cell associated with the first base station. In response to determining that the cell access status information indicates a barred status for the cell associated with the first base station, a determination can be made as to whether the SIB1 includes an Information Element (IE) that indicates a barred cell status exception for emergency information messaging. In response to determining that the SIB1 includes an IE that indicates a barred cell status exception for emergency information messaging, an active cell selection for the cell associated with the first base station can be established for at least a limited purpose of supporting emergency information messaging.

According to a possible implementation, the establishing an active cell selection includes camping on the cell to obtain limited services including the support of emergency information messaging. According to a further possible implementation, support of emergency information messaging includes originating emergency calls, and receiving Earthquake and Tsunami Warning System (ETWS) and Commercial Mobile Alert Service (CMAS) notifications. According to a still further implementation, the IE, that indicates the barred cell status exception for emergency information messaging is an Allow-Emergency-and-PS IE, which has a boolean value, which when set to true, enables a UE to consider this cell as an acceptable cell for purposes of supporting emergency information messaging.

According to a possible implementation, the IE that indicates a barred cell status exception is only included in the SIB1, when the MIB includes an indication of a UE cell access status of barred. According to a further implementation, the IE that indicates a barred cell status exception is a new IE established for providing the barred cell status exception. According to a still further implementation, the IE that indicates a barred cell status exception is an already available IE, which is repurposed for providing the barred cell status exception, when it is included as part of the SIB1.

According to a possible implementation, a non-Network Energy Savings UE can receive a repurposed cellBarredNES IE for indicating a barred cell status exception. According to a further implementation, a non-Network Energy Savings UE can receive a repurposed ims-Emergency Support IE for indicating a barred cell status exception.

In some instances, a broadcast of the SIB1 includes a new list of features which are either allowed or not allowed for intra frequency reselection, when the cell access status information indicates a barred status for the cell associated with the first base station, and an intra frequency reselection status in the MIB is set to not allowed.

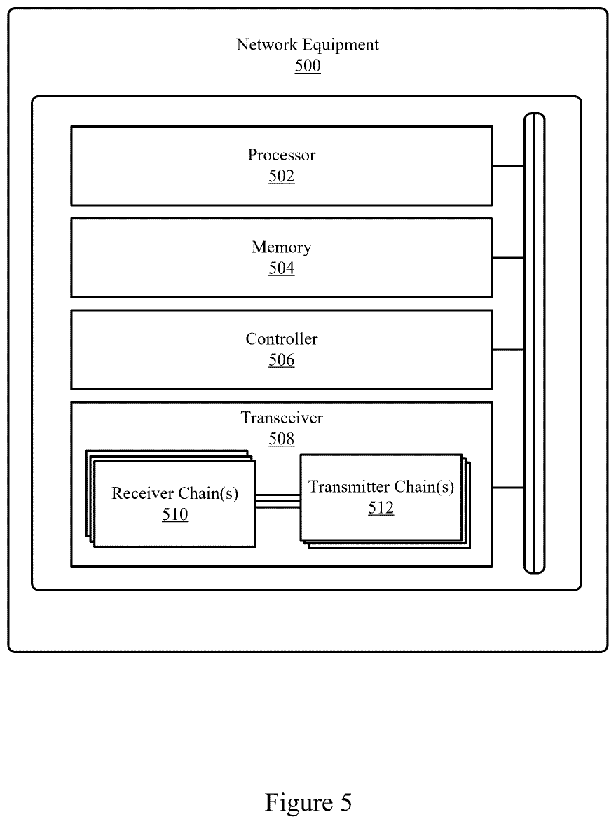

FIG. 5 illustrates an example of an NE 500 in accordance with aspects of the present disclosure. The NE 500 may include a processor 502, a memory 504, a controller 506, and a transceiver 508. The processor 502, the memory 504, the controller 506, the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such the memory 504 or another type of memory. Computer-readable media includes both non-transitory computer storage media and communication media including any medium that facilitates the transfer of a computer program from one place to another. A non-transitory storage medium may be any available medium that may be accessed by a general-purpose or special-purpose computer.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent at least one wireless transceiver and may include other transceivers, such as a wired transceiver, like a network interface. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., an LNA) configured to amplify the received signal. The receiver chain 510 may include at least one demodulator configured to demodulate the received signal and obtain the transmitted data by reversing the modulation technique applied during the transmission of the signal. The receiver chain 510 may include at least one decoder for decoding the processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more modulation techniques such as AM, FM, or digital modulation schemes like PSK or QAM, and/or any other modulation techniques. The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

In some implementations, the processor 502 and the memory 504 coupled with the processor 502 may be configured to cause the NE 500 to perform one or more of the functions described herein (e.g., executing, by the processor 502, instructions stored in the memory 504). For example, the processor 502 may support wireless communication at the NE 500 in accordance with examples as disclosed herein.

In operation according to a possible implementation, the at least one processor 502 can be configured to support a means for determining a cell access status information for at least a particular User Equipment (UE). The at least one processor 502 can be further configured to support a means for transmitting a Master Information Block (MIB) including the cell access status information including a potential indication of a status of barred from a first base station. In response to determining that the cell access status information for at least the particular UE indicates a barred status for the cell associated with the first base station, a determination can be made as to whether an Information Element (IE) that indicates a barred cell status exception for emergency information messaging should be made for at least a limited purpose of supporting emergency information messaging. In response to determining that the barred cell status exception for emergency information messaging should be made for the at least particular UE, a System Information Block Type 1 (SIB1) can be transmitted from the first base station, which includes the barred cell status exception.

In some implementations, the processor 502 and the memory 504 coupled with the processor 502 may be configured to cause the NE 500 (e.g., base station) to perform one or more of the functions described herein (e.g., executing, by the processor 502, instructions stored in the memory 504). For example, the processor 502 may support wireless communication at the NE 500 in accordance with examples as disclosed herein. The NE 500 may be configured to or operable to support a means for transmitting, to a UE, a MIB including a cell barred IE for a cell associated with the base station; and transmitting, to the UE, a SIB1, where the SIB1 includes a cell barred exception IE that indicates an exception for emergency communication on the barred cell, and where the cell provides limited services, including the emergency communication to the UE based on the SIB1 including the cell barred exception IE that indicates the exception for the emergency communication on the barred cell.

Additionally, the NE 500 may be configured to or operable to support any one or combination of the cell barred exception IE has a Boolean value. The cell barred exception IE is only included in the SIB1.

Additionally, or alternatively, the NE 500 may support at least one memory (e.g., the memory 504) and at least one processor (e.g., the processor 502) coupled with the at least one memory and configured to or operable to cause the NE to transmit, to a UE, a MIB including a cell barred IE for a cell associated with the base station; and transmit, to the UE, a SIB1, where the SIB1 includes a cell barred exception IE that indicates an exception for emergency communication on the barred cell, and where the cell provides limited services, including the emergency communication to the UE based on the SIB1 including the cell barred exception IE that indicates the exception for the emergency communication on the barred cell.

Additionally, the NE 500 may be configured to or operable to support any one or combination of the cell barred exception IE has a Boolean value. The cell barred exception IE is only included in the SIB1.

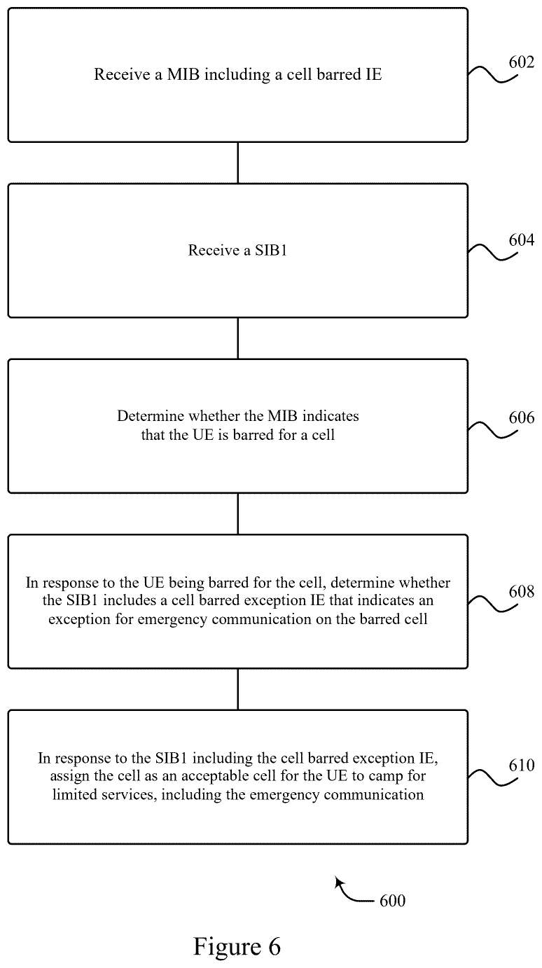

FIG. 6 illustrates an example flowchart 600 of a method in accordance with aspects of the present disclosure. The operations of the method may be implemented by a UE, as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible. In some implementations, aspects of the operations of 602-610 may be performed by a UE as described with reference to the device of FIG. 3.

At 602, method may include receiving a MIB including a cell barred IE. At 604, the method may include receiving a SIB1. At 606, the method may include determining whether the MIB indicates that the UE is barred for a cell. At 608, the method may include, in response to the UE being barred for the cell, determining whether the SIB1 includes a cell barred exception IE that indicates an exception for emergency communication on the barred cell. At 610, the method may include, in response to the SIB1 including the cell barred exception IE, assigning the cell as an acceptable cell for the UE to camp for limited services, including the emergency communication.

In one or more implementations, a method may include receiving a MIB including cell access status information including a potential indication of a status of barred from a first base station. A SIB1 can be received from the first base station. The method can further include determining if the MIB indicates a UE cell access status of barred for a cell associated with the first base station. In response to determining that the cell access status information indicates a barred status for the cell associated with the first base station, a determination is made as to whether the SIB1 includes an IE that indicates a barred cell status exception for emergency information messaging. In response to determining that the SIB1 includes an IE that indicates a barred cell status exception for emergency information messaging, an active cell selection for the cell associated with the first base station can be established for at least a limited purpose of supporting emergency information messaging.

According to a possible implementation, the establishing an active cell selection includes camping on the cell to obtain limited services including the support of emergency information messaging. According to a further possible implementation, support of emergency information messaging includes originating emergency calls, and receiving Earthquake and Tsunami Warning System (ETWS) and Commercial Mobile Alert Service (CMAS) notifications. According to a still further implementation, the IE, that indicates the barred cell status exception for emergency information messaging is an Allow-Emergency-and-PS IE, which has a boolean value, which when set to true, enables a UE to consider this cell as an acceptable cell for purposes of supporting emergency information messaging.

According to a possible implementation, the IE that indicates a barred cell status exception is only included in the SIB1, when the MIB includes an indication of a UE cell access status of barred. According to a further implementation, the IE that indicates a barred cell status exception is a new IE established for providing the barred cell status exception. According to a still further implementation, the IE that indicates a barred cell status exception is an already available IE, which is repurposed for providing the barred cell status exception, when it is included as part of the SIB1.

According to a possible implementation, a non-Network Energy Savings UE can receive a repurposed cellBarredNES IE for indicating a barred cell status exception. According to a further implementation, a non-Network Energy Savings UE can receive a repurposed ims-EmergencySupport IE for indicating a barred cell status exception.

In some instances, a broadcast of the SIB1 includes a new list of features which are either allowed or not allowed for intra frequency reselection, when the cell access status information indicates a barred status for the cell associated with the first base station, and an intra frequency reselection status in the MIB is set to not allowed.

It should be noted that the method described herein describes a possible implementation, and that the operations and the steps may be rearranged or otherwise modified and that other implementations are possible.

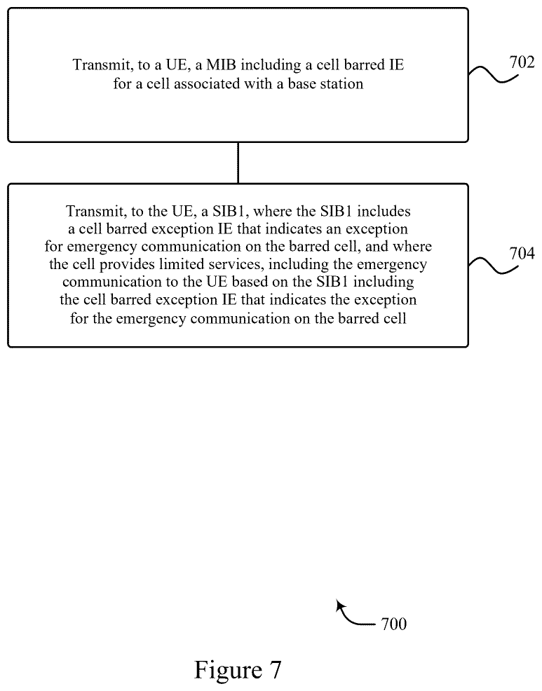

FIG. 7 illustrates an example flowchart 700 of a method in accordance with aspects of the present disclosure. The operations of the method may be implemented by a NE. In some implementations, the NE may execute a set of instructions to control the function elements of the NE to perform the described functions. It should be noted that the method described herein describes a possible implementation, and that the operations and the steps may be rearranged or otherwise modified and that other implementations are possible. In some implementations, aspects of the operations of 702 and 704 may be performed by a base station as described with reference to the NE of FIG. 5.

At 702, the method may include transmitting, to a UE, a MIB including a cell barred IE for a cell associated with a base station. At 704, the method may include transmitting, to the UE, a SIB1, where the SIB1 includes a cell barred exception IE that indicates an exception for emergency communication on the barred cell, and where the cell provides limited services, including the emergency communication to the UE based on the SIB1 including the cell barred exception IE that indicates the exception for the emergency communication on the barred cell.

In one or more implementations, a method may include determining a cell access status information for at least a particular UE. An MIB including the cell access status information including a potential indication of a status of barred from a first base station is transmitted. In response to determining that the cell access status information for at least the particular UE indicates a barred status for the cell associated with the first base station, a determination is made as to whether an IE that indicates a barred cell status exception for emergency information messaging should be made for at least a limited purpose of supporting emergency information messaging. In response to determining that the barred cell status exception for emergency information messaging should be made for the at least particular UE, a SIB1 is transmitted from the first base station, which includes the barred cell status exception.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

At least some methods of this disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure.

At least some implementations can improve operation of the disclosed devices. Various components of the implementations may be interchanged, added, or substituted in the other implementations. Also, all of the elements of each figure are not necessary for operation of the disclosed implementations. For example, one of ordinary skill in the art of the disclosed implementations would be enabled to make and use the teachings of the disclosure by simply employing the elements of the independent claims. Accordingly, implementations of the disclosure as set forth herein are intended to be illustrative, not limiting. Various changes may be made without departing from the spirit and scope of the disclosure.

The terms “comprises,” “comprising,” “including,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, the term “another” is defined as at least a second or more. The terms “including,” “having,” and the like, as used herein, are defined as “comprising.” Terms of approximation, such as “approximately,” “near,” “substantially,” and/or other related terms, unless otherwise defined, are defined as a range within +/−5% of the approximated element, a range within +/−10% of the approximated element, and/or a range close enough to the approximated element to achieve an intended result. All elements of the disclosed implementations can be modified with such terms. In this document, relational terms such as “first,” “second,” and the like may be used solely to distinguish one entity or action from another entity or action without necessarily requiring or implying any actual such relationship or order between such entities or actions.

The background section is not admitted as prior art, is written as the inventor's own understanding of the context of some implementations at the time of filing, and includes the inventor's own recognition of any problems with existing technologies and/or problems experienced in the inventor's own work.

What is claimed is:

1. A user equipment (UE) for wireless communication, comprising:
at least one memory; and
at least one processor coupled with the at least one memory and operable to cause the UE to:
receive a master information block (MIB) including a cell barred information element (IE);
receive a system information block type 1 (SIB1);
determine whether the MIB indicates that the UE is barred for a cell;
in response to the UE being barred for the cell, determine whether the SIB1 includes a cell barred exception IE that indicates an exception for emergency communication on the barred cell; and
in response to the SIB1 including the cell barred exception IE, assign the cell as an acceptable cell for the UE to camp for limited services, including the emergency communication.

2. The user equipment of claim 1, wherein the at least one processor is operable to cause the UE to establish an active cell selection by camping on the cell to obtain the limited services, including the emergency communication.

3. The user equipment of claim 1, wherein the cell barred IE indicates a barred cell exception for emergency information messaging as an Allow-Emergency-and-PS IE, which includes a Boolean value set to true that enables the UE to consider the cell as an acceptable cell for the emergency communication.

4. The user equipment of claim 1, wherein the cell barred IE that indicates a barred cell exception is established to provide a barred cell status exception.

5. The UE of claim 1, wherein the at least one processor is operable to cause the UE to camp on the cell for the limited services, including the emergency communication.

6. The UE of claim 1, wherein the cell barred exception IE has a Boolean value.

7. The UE of claim 6, wherein the at least one processor is operable to cause the UE to assign the cell as the acceptable cell for the UE to camp for the limited services based at least in part on the Boolean value of true.

8. The UE of claim 1, wherein the cell barred exception IE is only included in the SIB1.

9. A method performed by a user equipment (UE), the method comprising:
receiving a master information block (MIB) including a cell barred information element (IE);
receiving a system information block type 1 (SIB1);
determining whether the MIB indicates that the UE is barred for a cell;
in response to the UE being barred for the cell, determining whether the SIB1 includes a cell barred exception IE that indicates an exception for emergency communication on the barred cell; and
in response to the SIB1 including the cell barred exception IE, assigning the cell as an acceptable cell for the UE to camp for limited services, including the emergency communication.

10. The method of claim 9, further comprising camping on the cell for the limited services, including the emergency communication.

11. The method of claim 9, wherein the cell barred exception IE has a Boolean value.

12. The method of claim 11, further comprising:
assigning the cell as the acceptable cell for the UE to camp for the limited services based at least in part on the Boolean value of true.

13. The method of claim 9, wherein the cell barred exception IE is only included in the SIB1.

14. The method of claim 9, further comprising:
establishing an active cell selection by camping on the cell to obtain the limited services, including the emergency communication.

15. A base station for wireless communication, comprising:
at least one memory; and
at least one processor coupled with the at least one memory and operable to cause the base station to:
transmit, to a user equipment (UE), a master information block (MIB) including a cell barred information element (IE) for a cell associated with the base station; and
transmit, to the UE, a system information block type 1 (SIB1), wherein the SIB1 includes a cell barred exception IE that indicates an exception for emergency communication on the barred cell, and wherein the cell provides limited services, including the emergency communication to the UE based at least in part on the SIB1 including the cell barred exception IE that indicates the exception for the emergency communication on the barred cell.

16. The base station of claim 15, wherein the cell barred exception IE has a Boolean value.

17. The base station of claim 15, wherein the cell barred exception IE is only included in the SIB1.

18. A method performed by a base station, the method comprising:
transmitting, to a user equipment (UE), a master information block (MIB) including a cell barred information element (IE) for a cell associated with the base station; and
transmitting, to the UE, a system information block type 1 (SIB1), wherein the SIB1 includes a cell barred exception IE that indicates an exception for emergency communication on the barred cell, and wherein the cell provides limited services, including the emergency communication to the UE based at least in part on the SIB1 including the cell barred exception IE that indicates the exception for the emergency communication on the barred cell.

19. The method of claim 18, wherein the cell barred exception IE has a Boolean value.

20. The method of claim 18, wherein the cell barred exception IE is only included in the SIB1.
